(19) United States
(12) Patent Application Publication
(10) Pub. No.: US 2003/0076683 A1
(43) Pub. Date: Apr. 24, 2003

(54) Heat-dissipating structure for switching an air direction

(76) Inventor: Han-Chung Chang, Hsinchu (TW)

Correspondence Address: GAZDZINSKI & ASSOCIATES, 11440 WEST BERNARDO COURT, SUITE 375, SAN DIEGO, CA, 92127, US

(21) Appl. No.: 10/045,130

(22) Filed: Oct. 18, 2001

(51) Int. Cl. F21V 29/02; G03B 21/16

(52) U.S. Cl. 362/294; 362/373; 353/61

(57) ABSTRACT

A heat-dissipating structure for switching an air direction is provided. The heat-dissipating structure for switching an air direction is used for dissipating the heat generated from a bulb according to one of an upright state and an inverse state of an apparatus provided with the heat-dissipating structure and having a body placing thereon the bulb, including: a wind-supply device and an air direction switching device. The wind-supply device is mounted in the body for supplying a wind flow to a first side of the bulb for dissipating heat along a first wind direction while the apparatus is at the upright state. The air direction switching device is mounted in the body and includes a guiding region for guiding the wind flow to a second opposite side of the bulb along a second wind direction while the apparatus is at the inverse state.

### FIELD OF THE INVENTION

The present invention is related to a heat-dissipating structure, and more particularly, to a heat-dissipating structure for switching an air direction in a liquid crystal projector. The heat-dissipating structure is used for dissipating the heat generated from the bulb according to one of an upright state and an inverse state of an apparatus provided with the heat-dissipating structure and having a body placing thereon the bulb. The heat-dissipating structure includes a wind-supply device and an air direction switching device. The life-span of the bulb used in a general liquid crystal projector can be prolonged effectively by using the heat-dissipating structure for switching an air direction provided in the present invention.

### BACKGROUND OF THE INVENTION

The liquid crystal projector can generally perform several types of projection, for example, the real time projection of the pictures taken by a document camera, the projection of video graphics array (VGA) of a personal computer, or the projection of the video signal received from a home movie theater onto a 40-inch screen. It is necessary to use a lighting bulb in a liquid crystal projector. The temperature of the bulb is as high as 900˜1000° C. Therefore, in order to prolong the life span of the bulb and prevent it from bursting caused by rapid deterioration and aging, there is usually a heat-dissipating structure mounted in the liquid crystal projector to help the cooling. At present, the projecting way of the projector includes two mounting types. One is that the projector is at the upright state when placed on the table, and the other is that the projector is at the inverse state when mounted inversely underneath the ceiling. The heat generated from the bulb is therefore centralized to different sites. However, the form of heat-dissipating structure is not considered to fit the dissipating situation of the generated heat according to either specific one of an upright state and an inverse state of the projector.

Please refer to FIG. 1. FIG. 1 is a lateral view showing the form of heat-dissipating structure of a liquid crystal projector according to the prior art. The bulb 10 is mounted in the lampshade 14. While the projector is at the upright state, the temperatures at the first side of the bulb 12 and second opposite side 13 of the bulb 10 are 1100° C. and 900° C. respectively. The temperature difference is about 200° C. While the projector is at the inverse state, the positions of the first side 12 of the bulb 10 and second opposite side 13 of the bulb 10 are exchanged mutually up side down, and the temperatures are 900° C. and 1100° C. respectively. Some factory owners seal the lampshade 14 up with the flame-proof glass 11. However, due to the lack of the hole to help cool, the fan can only cool the outer covering of the lampshade 14 to help lower the temperature. This kind of heat-dissipating form can not effectively lower the temperature difference between the upper side and the down side of the bulb 10. The famous manufacturer, the Japanese Hitachi, mounts a ventilating hole at the lateral side of the lampshade 14 to let the wind flow in. Nevertheless, the direction of the wind flow is still not arranged to fit the different situation according to either one of an upright state and an inverse state of the projector. It is hence not an ideal heat-dissipating form either.

Furthermore, the experimental result shows: if the fan does not blow the first side 12 of the bulb 10 which has the highest temperature, but blows the second opposite side 13 of the bulb 10 which has the lowest temperature instead, the temperature would be 750° C. and 1050° C. respectively. The temperature difference gets higher as about 300° C., which is very disadvantageous to the stability of the glass structure on the surface of the bulb 10.

In order to overcome the foresaid drawback, the present invention provides a heat-dissipating structure for switching an air direction for dissipating a heat generated from a bulb according to one of an upright state and an inverse state of a liquid crystal projector. Not only the foresaid technical problem is solved, but also the temperature difference between the upper side and the down side of the bulb is lowered to a minimum in the present invention.

### SUMMARY OF THE INVENTION

It is an object of the present invention to provide a heat-dissipating structure for switching an air direction for dissipating the heat generated from a bulb according to one of an upright state and an inverse state of a liquid crystal projector.

It is another object of the present invention to guide the wind flow to the different sides of the bulb along different wind directions respectively by using the mounted vertical blocking board and tilted blocking board.

It is another object of the present invention to provide a heat-dissipating structure for switching an air direction for dissipating the heat generated from the bulb according to one of an upright state and an inverse state of an apparatus provided with the heat-dissipating structure and having a body placing thereon the bulb, including: a wind-supply device and an air direction switching device. The wind-supply device is mounted in the body for supplying a wind flow to a first side of the bulb for dissipating heat along a first wind direction while the apparatus is at the upright state. The air direction switching device is mounted in the body and including a guiding region for guiding the wind flow to a second opposite side of the bulb along a second wind direction while the apparatus is at the inverse state.

In accordance with the present invention, the apparatus is a liquid crystal projector.

In accordance with the present invention, the wind-supply device is a fan.

In accordance with the present invention, a bulb base is mounted in the body for fixing the bulb.

In accordance with the present invention, the first side of the bulb is higher than the second opposite side of the bulb while the apparatus is at the upright state, and the second opposite side of the bulb is higher than the first side of the bulb while the apparatus is at the inverse state.

In accordance with the present invention, the air direction switching device includes a vertical blocking board for guiding the wind flow to the first side of the bulb along the first wind direction, and a tilted blocking board for guiding the wind flow to the second opposite side of the bulb along the second wind direction.

Preferably, the apparatus further includes a bottom cover for placing thereon vertically the tilted blocking board.

Preferably, the air direction switching device includes a pivot for pivoting the tilted blocking board from a vertical status on the bottom cover to a horizontal status and switching from the guiding region of the vertical blocking board to the guiding region of the tilted blocking board, simultaneously.

Preferably, the tilted blocking board is pivoted naturally from a vertical status on the bottom cover to a horizontal status by a gravity force while the apparatus is changed from the upright state to the inverse state.

Preferably, the temperatures at the first side of the bulb and second opposite side of the bulb are 860° C. and 820° C. respectively while the projector is at the upright state, and the temperatures are 800° C. and 860° C. respectively while the projector is at the inverse state.

Preferably, the wind flow along the first wind direction of the wind-supply device blows the first side of the bulb along a reflective lampshade.

Preferably, the wind-supply device is mounted in front of the underside of the bulb base while the apparatus is at the upright state.

It is another object of the present invention to provide a heat-dissipating structure for switching an air direction for dissipating the heat generated from a bulb according to one of an upright state and an inverse state of an apparatus provided with the heat-dissipating structure and having a body placing thereon the bulb, including: a wind-supply device and an air direction switching device. The wind-supply device is mounted in the body for supplying a wind flow to a first side of the bulb for dissipating heat along a third wind direction while the apparatus is at the upright state. The air direction switching device is mounted at the central location of a lateral side of the bulb base and including a guiding region for guiding the wind flow to a second opposite side of the bulb along a fourth wind direction while the apparatus is at the inverse state.

In accordance with the present invention, the apparatus is a liquid crystal projector.

In accordance with the present invention, a bulb base is mounted in the body for fixing the bulb.

Preferably, the wind-supply device includes a wind-delivery exit, and the air direction switching device includes a two-way blocking board mounted at a central location in front of the wind-delivery exit to be switched back and forth between the third and fourth wind directions.

Preferably, the air direction switching device comprises a pivot, and the two-way blocking board includes a first wind-blocking side and a second wind-blocking side for being switched to the respective guiding region of the first and second wind-blocking sides through the pivot.

Preferably, the air direction switching device includes a first wind channel and a second wind channel for delivering the wind flow to the first side of the bulb and the second opposite side of the bulb respectively.

It is another object of the present invention to provide a heat-dissipating structure for switching an air direction for dissipating the heat generated from a bulb according to one of an upright state and an inverse state of an apparatus provided with the heat-dissipating structure and having a body placing thereon the bulb, including: a first wind-supply device, a second wind-supply device, and an air direction switching device. The first wind-supply device and a second wind-supply device are mounted in the body for supplying a wind flow to a first side of the bulb for dissipating heat along a fifth wind direction while the apparatus is at the upright state. The air direction switching device is mounted in the body and including a starting region for making the wind flow to a second opposite side of the bulb along a sixth wind direction while the apparatus is at the inverse state.

In accordance with the present invention, the apparatus is a liquid crystal projector.

In accordance with the present invention, a bulb base is mounted in the body for fixing the bulb.

Preferably, the air direction switching device is a control circuit and includes a starting region.

Preferably, the starting region is a screen control button electrically connected with the control circuit for switching the wind-supply function performed by the first wind-supply device to that performed by the second wind-supply device and activating the wind flow to the second opposite side of the bulb along the sixth wind direction.

The foregoing and other features and advantages of the present invention will be more clearly understood through the following descriptions with reference to the drawings, wherein:

### BRIEF DESCRIPTION OF THE DRAWINGS

FIG. 1 is a lateral view showing the form of heat-dissipating structure of a liquid crystal projector according to the prior art;

FIG. 2 is a three-dimensional diagram showing the heat-dissipating structure for switching an air direction according to the preferred embodiment of the present invention;

FIG. 3(A) is a lateral view showing the heat-dissipating structure according to FIG. 2;

FIG. 3(B) is a three-dimensional diagram showing the heat-dissipating structure according to FIG. 3(A);

FIG. 4 is a three-dimensional diagram showing the heat-dissipating structure of a liquid crystal projector according to FIG. 2;

FIG. 5(A) is a lateral view showing the heat-dissipating structure of a liquid crystal projector while the liquid crystal projector is at the inverse state according to FIG. 2;

FIG. 5(B) is a three-dimensional diagram showing the heat-dissipating structure according to FIG. 5(A);

FIG. 6 is a three-dimensional diagram showing the bottom cover of the liquid crystal projector according to FIG. 4;

FIG. 7 is a front view showing the air direction switching device according to FIG. 5(A);

FIG. 8 is a lateral view showing the heat-dissipating structure for switching an air direction while the liquid crystal projector is at the upright state according to another preferred embodiment of the present invention;

FIG. 9 is a lateral view showing the heat-dissipating structure while the liquid crystal projector is at the inverse state according to FIG. 8;

FIG. 10 is a three-dimensional diagram showing the main portions of the heat-dissipating structure according to FIG. 8;

FIG. 11 is a lateral view showing the heat-dissipating structure for switching an air direction while the liquid crystal projector is at the upright state according to another preferred embodiment of the present invention;

FIG. 12 is a lateral view showing the heat-dissipating structure while the liquid crystal projector is at the inverse state according to FIG. 1;

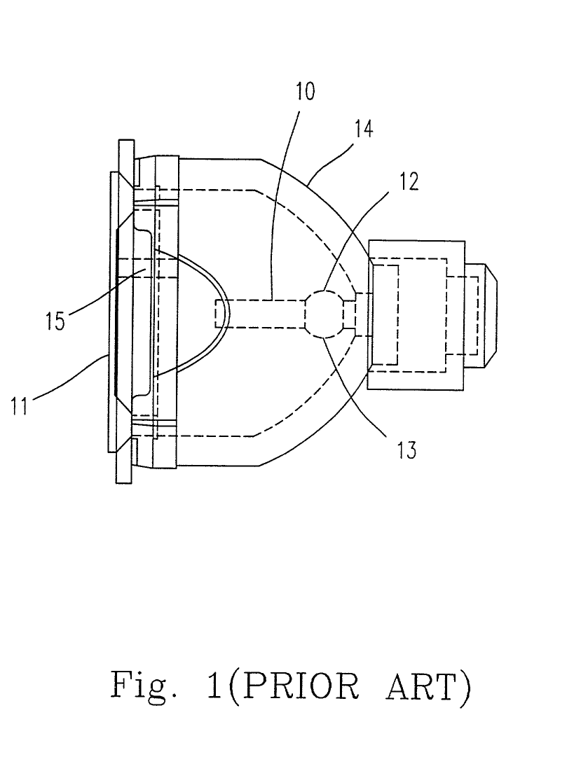

### DETAILED DESCRIPTION OF THE PREFERRED EMBODIMENT

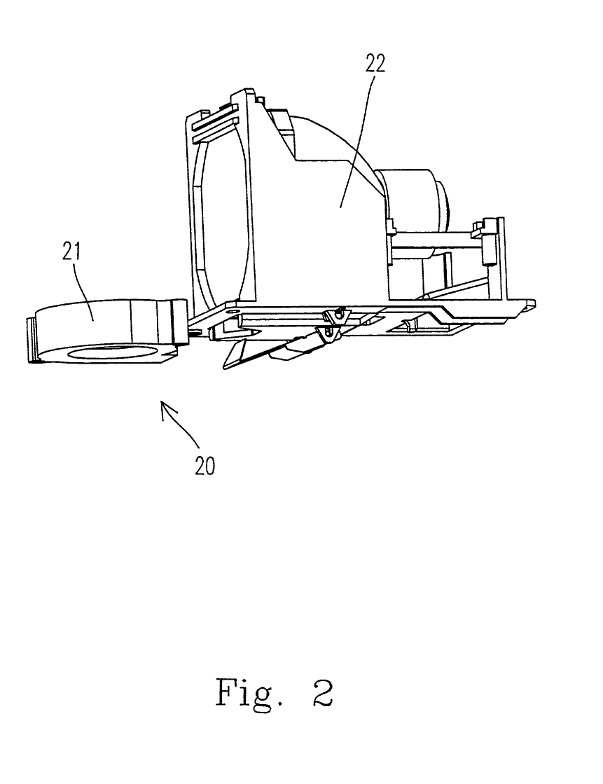

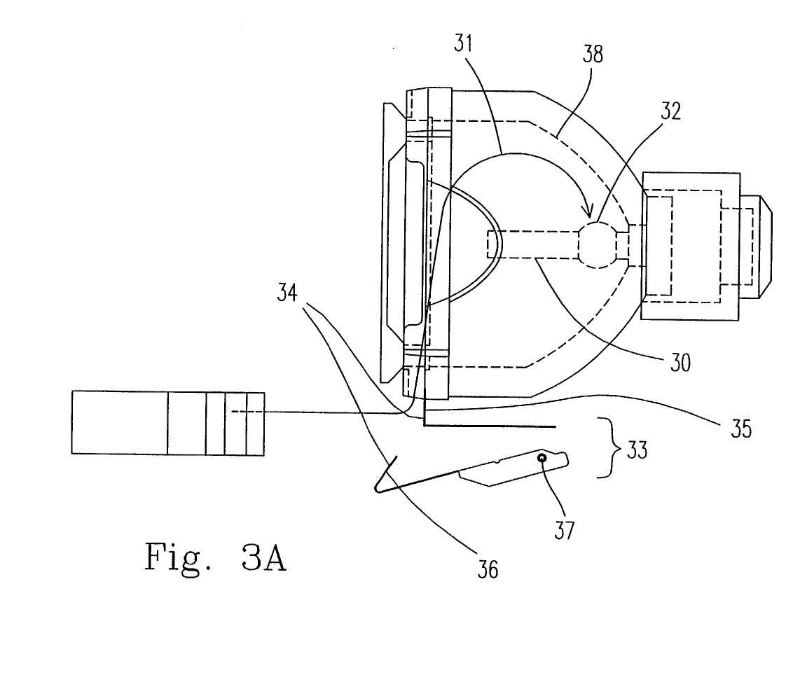

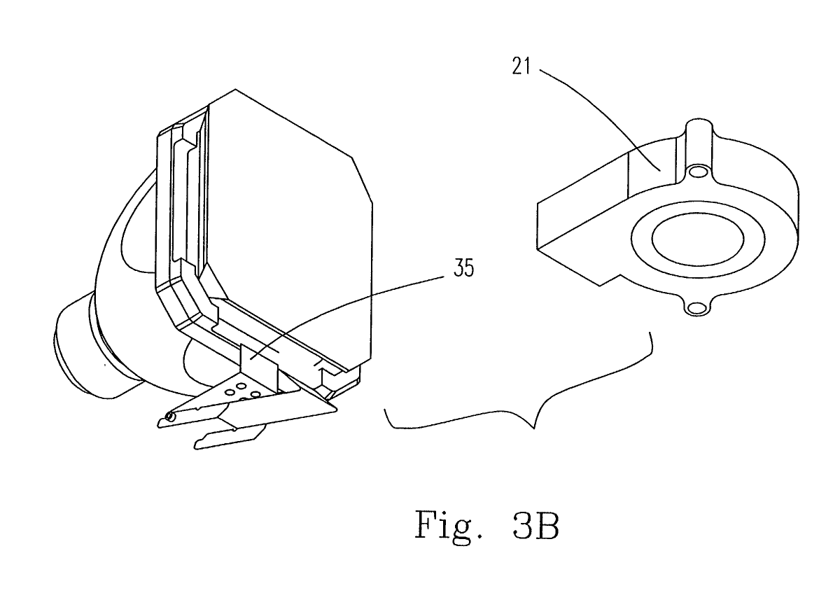

The present invention will now described more specifically with reference to the following embodiments. Please refer to FIG. 2-FIG. 5(A). The heat-dissipating structure 20 for switching an air direction is used for dissipating the heat generated from the bulb 30 according to one of an upright state (FIG. 3 (A)) and an inverse state (FIG. 4) of the liquid crystal projector 40 provided with the heat-dissipating structure 20 and having a body 41 placing thereon the bulb 30, including: a wind-supply device 21 and an air direction switching device 33. In FIG. 3(A), the wind-supply device 21 is mounted on the bulb base 22 for supplying a wind flow to a first side 32 of the bulb 30 for dissipating heat along a first wind direction 31 while the liquid crystal projector 40 is at the upright state. In FIG. 4, the air direction switching device 33 is mounted in the body 41 and includes a guiding region 34 for guiding the wind flow to a second opposite side 51 of the bulb 30 along a second wind direction 50 while the liquid crystal projector 40 is at the inverse state. In FIG. 3(A), the bulb base 22 is mounted in the body 41 for fixing the bulb 30.

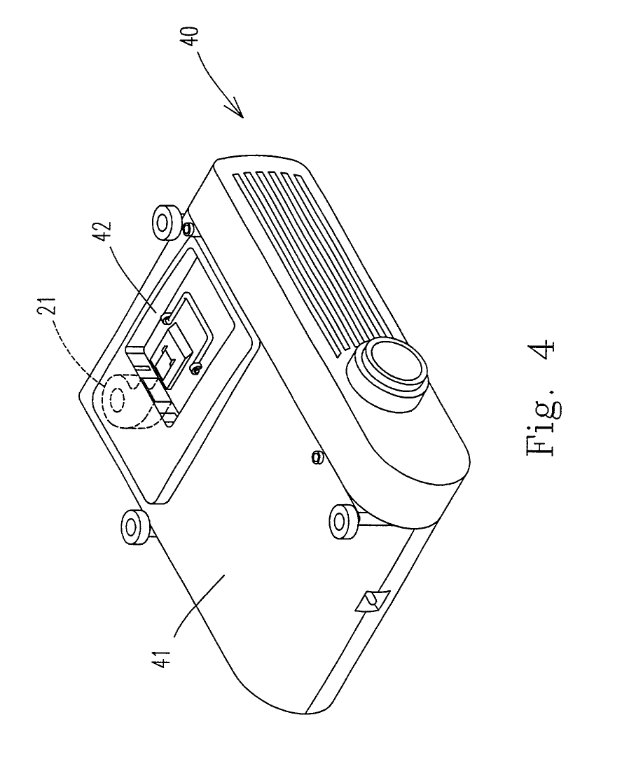

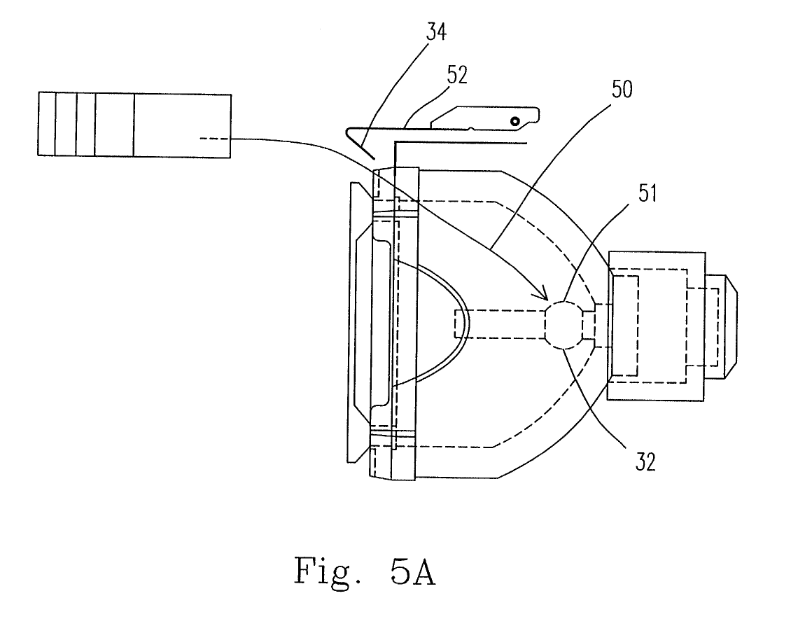

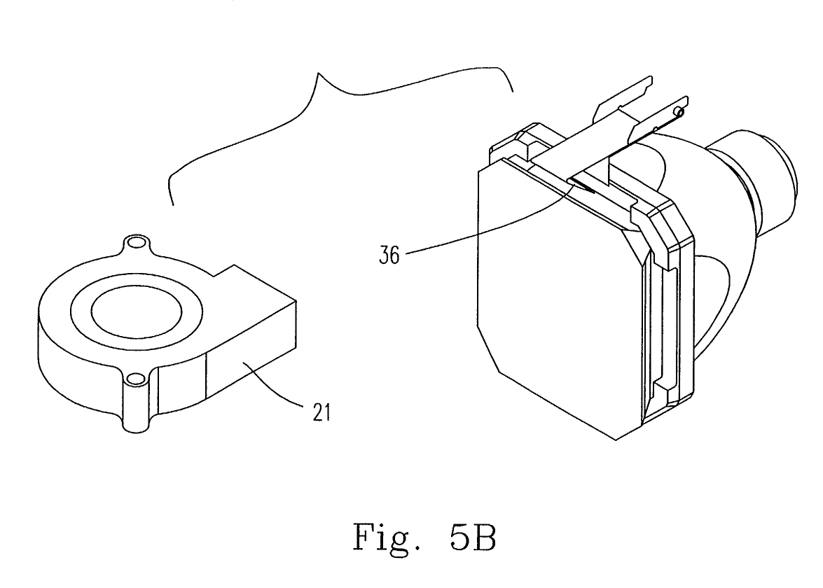

The wind-supply device 21 of the heat-dissipating structure 20 is a fan 21. The first side 32 of the bulb 30 is higher than the second opposite side 51 of the bulb 30 while the liquid crystal projector 40 is at the upright state, and said second opposite side 51 of the bulb 30 is higher than the first side 32 of the bulb 30 while the liquid crystal projector 40 is at the inverse state. In FIG. 3(A), the air direction switching device 33 includes a vertical blocking board 35 (mounted inside the bulb base 22 in FIG. 2) for guiding the wind flow to the first side 32 of the bulb 30 along the first wind direction 31 through the guiding region 34 while the liquid crystal projector 40 is at the upright state. In FIG. 3 (B), it can be seen clearly that the fan 21 blows the vertical blocking board 35 directly. The air direction switching device 33 includes a tilted blocking board 36 for guiding the wind flow to the second opposite side 51 of the bulb 30 along the second wind direction 50 through the guiding region 34 while the liquid crystal projector 40 is at the inverse state. In FIG. 6, the heat-dissipating structure 20 of the liquid crystal projector 40 further includes a bottom cover 60 for placing thereon vertically the tilted blocking board 36. Please refer to FIG. 5 (A). The air direction switching device 33 includes a pivot 37 for pivoting the tilted blocking board 36 from a vertical status on the bottom cover 60 to a horizontal status 52. In FIG. 5(B), it can be seen clearly that the fan 21 blows the tilted blocking board 36 directly. Meantime, the air direction switching device 33 makes the guiding region switched from the guiding region of the vertical blocking board to the guiding region of the tilted blocking board. Please refer to FIG. 7 which is a front view showing the air direction switching device 33 while the liquid crystal projector 40 is at the inverse state. Since the tilted blocking board 36 guides the wind flow slantingly, the guided wind flow will not hit the underside of the vertical blocking board 35.

The tilted blocking board 36 is pivoted naturally from a vertical status on the bottom cover 60 to a horizontal status by a gravity force while the liquid crystal projector 40 is changed from the upright state to the inverse state. In FIG. 3(A), the temperatures at the first side 32 of the bulb 30 and second opposite side 52 of the bulb 30 are 860° C. and 820° C. respectively while the liquid crystal projector 40 is at the upright state (where the temperature difference between the upper side and the down side of the bulb 30 is about 40° C., which means the side temperatures are lowered by 240 and 80 degrees respectively.). In FIG. 5(A), the temperatures at the first side 32 of the bulb 30 and second opposite side 52 of the bulb 30 are 800° C. and 860° C. respectively while the liquid crystal projector 40 is at the inverse state (where the temperature difference between the upper side and the down side of the bulb 30 is about 60° C., which means the side temperatures are lowered by 100 and 240 degrees respectively.). In such way, the temperature difference is lowered to be within 100 degrees. In FIG. 3(A), the wind flow along the first wind direction 31 of the wind-supply device 21 blows the first side 32 of the bulb 30 along a reflective lampshade 38. The wind-supply device 21 is mounted in front of the underside of the bulb base 22 while the liquid crystal projector 40 is at the upright state.

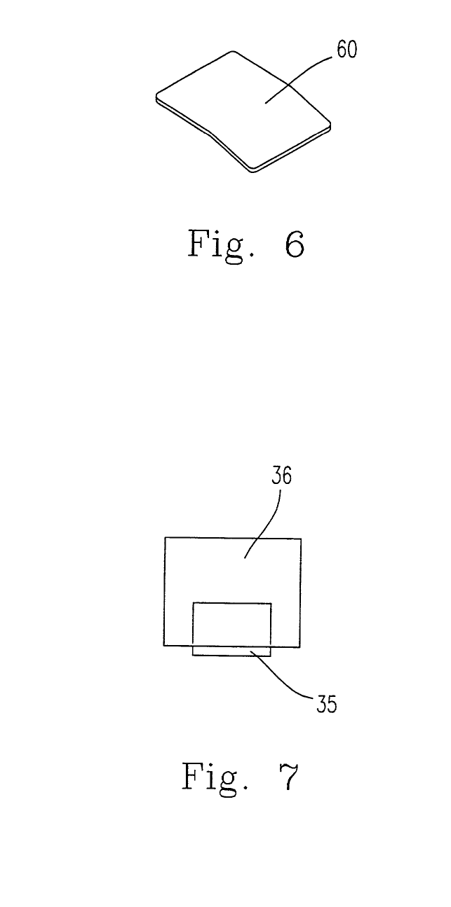

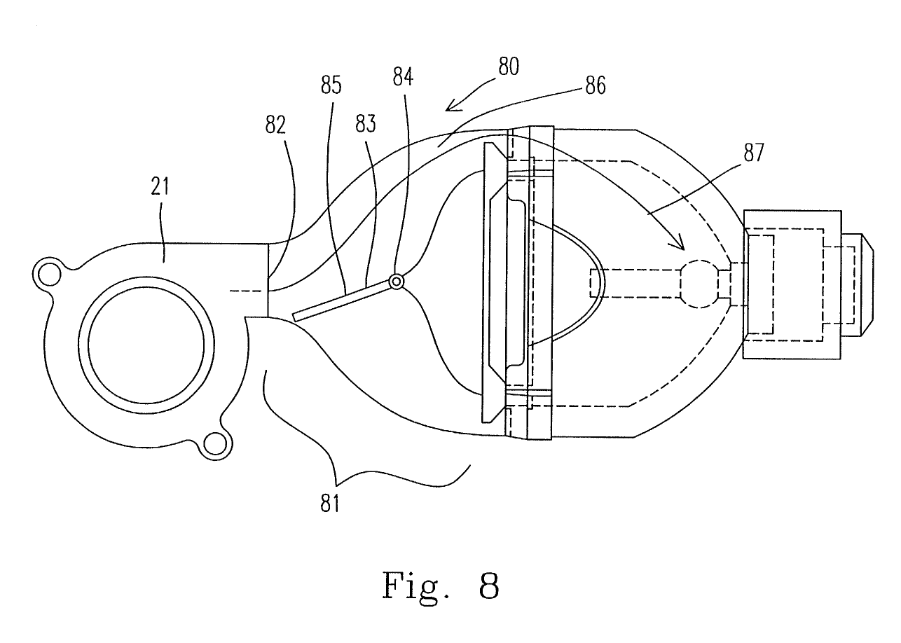

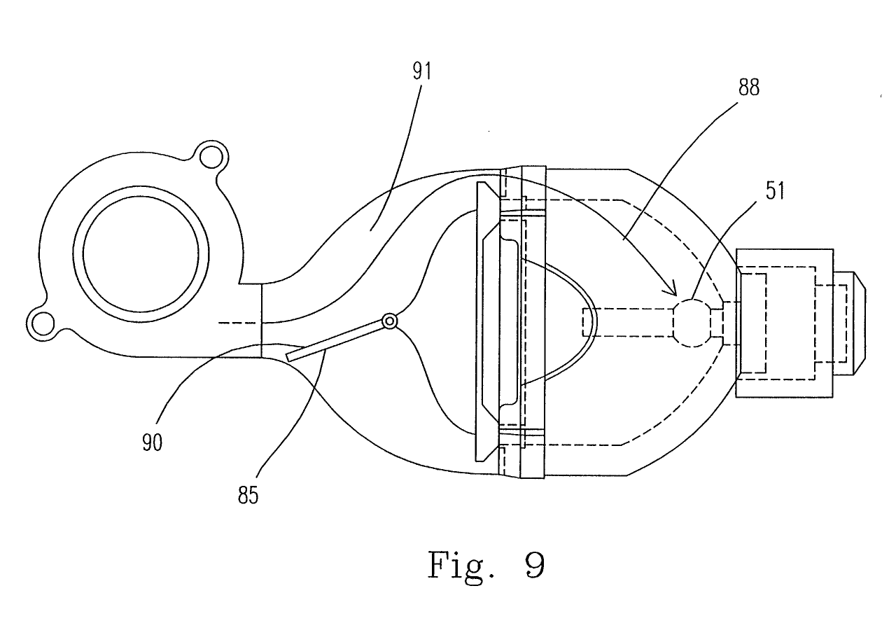

Please refer to FIG. 8-FIG. 10 which are views according to another preferred embodiment of the present invention. The heat-dissipating structure 80 for switching an air direction is used for dissipating the heat generated from the bulb 30 according to one of an upright state and an inverse state of the liquid crystal projector 40 provided with the heat-dissipating structure 80 and having a body 41 placing thereon the bulb 30, including: a wind-supply device 21 and an air direction switching device 81. The wind-supply device 21 is mounted in the body 41 for supplying a wind flow to a first side 32 of the bulb 30 for dissipating heat along a third wind direction 87 while the liquid crystal projector 40 is at the upright state. The air direction switching device 81 is mounted at the central location of a lateral side of the bulb base 22 (as shown in FIG. 10) and including a guiding region for guiding the wind flow to a second opposite side 51 of the bulb 30 along a fourth wind direction 88 while the liquid crystal projector 40 is at the inverse state. The bulb base 22 is mounted in the body 41 for fixing the bulb 30.

Please refer to FIG. 8. The wind-supply device 21 includes a wind-delivery exit 82, and the air direction switching device 81 includes a two-way blocking board 83 mounted at a central location in front of the wind-delivery exit 82 to be switched back and forth between the third and fourth wind direction 87 and 88. The air direction switching device 81 includes a pivot 84, and the two-way blocking board 83 includes a first wind-blocking side 85 and a second wind-blocking side 90 for being switched to the respective guiding region of the first and second wind-blocking sides 85 and 90 through the pivot 84. The air direction switching device 81 includes a first wind channel 86 and a second wind channel 91 for delivering the wind flow to the first side 32 of the bulb 30 and the second opposite side 51 of the bulb 30 respectively (wherein both the first and second wind channels 86 and 91 go around the flame-proof glass laterally and enter the inside of the lampshade from the central location of the upper side). We can see from FIG. 10 the deployment of the two-way blocking board 83 and the wind-supply device 21 while the liquid crystal projector 40 is at the upright state.

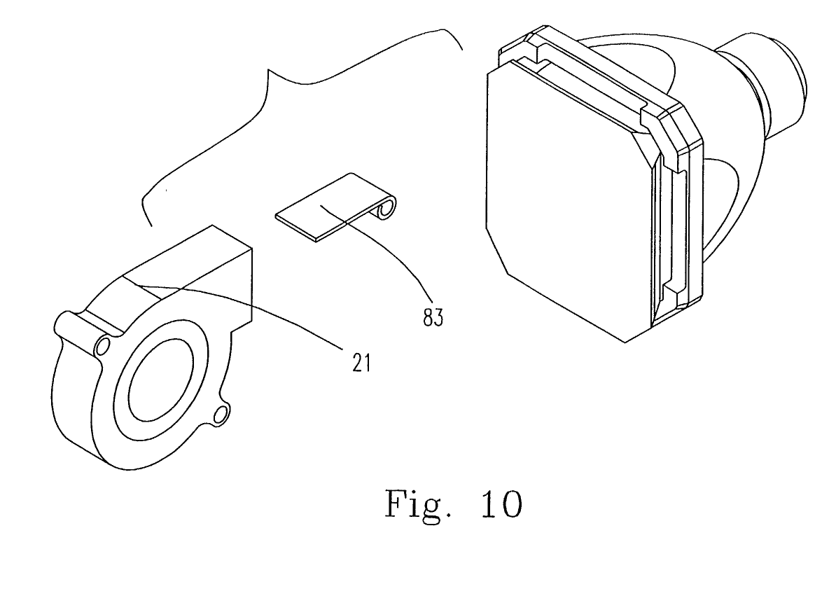

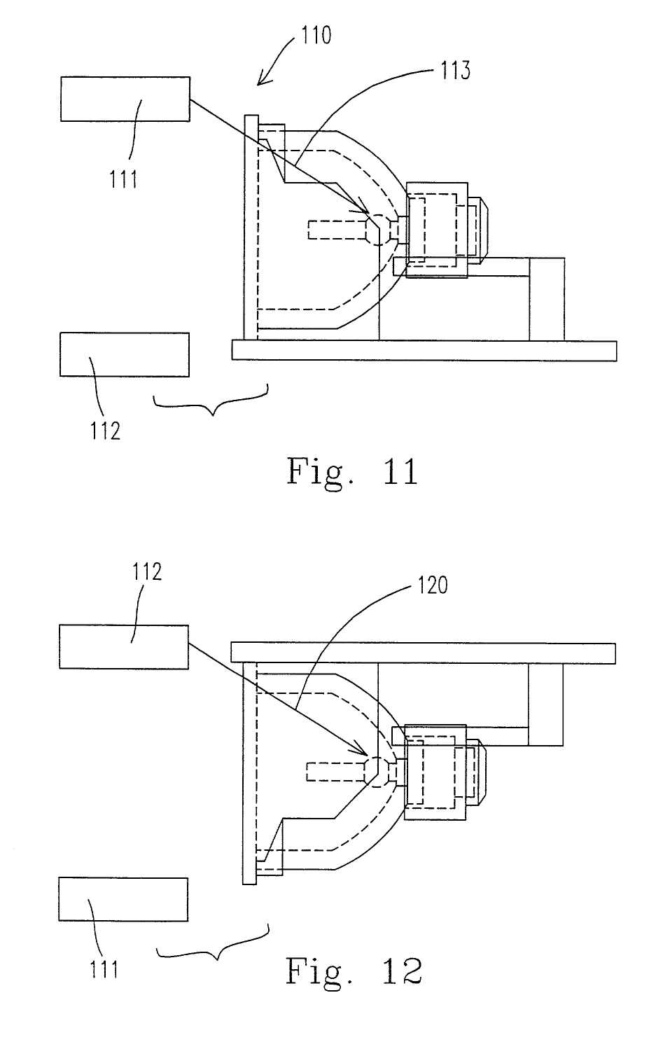

Please refer to FIG. 11 which is according to another preferred embodiment of the present invention. The heat-dissipating structure 110 for switching an air direction is used for dissipating the heat generated from a bulb 30 according to one of an upright state and an inverse state of the liquid crystal projector 40 provided with the heat-dissipating structure 110 and having a body 41 placing thereon the bulb 30, including: a first wind-supply device 111, a second wind-supply device 112, and an air direction switching device (not shown in diagram). The first wind-supply device 111 and the second wind-supply device 112 are mounted in the body 41 for supplying a wind flow to a first side 32 of the bulb 30 for dissipating heat along a fifth wind direction 113 while the liquid crystal projector 40 is at the upright state. The air direction switching device is mounted in the body 41 and includes a starting region for guilding the wind flow to a second opposite side 51 of the bulb 30 along a sixth wind direction 120 while the liquid crystal projector 40 is at the inverse state. The bulb base 22 is mounted in the body 41 for fixing the bulb 30.

The air direction switching device is a control circuit and includes a starting region. The starting region is a screen control button electrically connected with the control circuit for switching the wind-supply function performed by the first wind-supply device 111 to that performed by the second wind-supply device 112 and activating the wind flow to the second opposite side 51 of the bulb 30 along the sixth wind direction 120. The screen control button is (not shown in diagram) mounted on the body 41. While the liquid crystal projector 40 is changed from the upright state to the inverse state, the user has to push the screen control button, or the projected screen and caption will remain as they are in the upright state and get an inverse image.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A heat-dissipating structure for switching an air direction for dissipating a heat generated from a bulb according to one of an upright state and an inverse state of an apparatus provided with said heat-dissipating structure and having a body placing thereon said bulb, comprising:
a wind-supply device mounted in said body for supplying a wind flow to a first side of said bulb for dissipating heat along a first wind direction while said apparatus is at said upright state; and
an air direction switching device mounted in said body and including a guiding region for guiding said wind flow to a second opposite side of said bulb along a second wind direction while said apparatus is at said inverse state.

2. The heat-dissipating structure according to claim 1, wherein said apparatus is a liquid crystal projector.

3. The heat-dissipating structure according to claim 1, wherein said wind-supply device is a fan.

4. The heat-dissipating structure according to claim 1, wherein a bulb base is mounted in said body for fixing said bulb.

5. The heat-dissipating structure according to claim 1, wherein said first side of said bulb is higher than said second opposite side of said bulb while said apparatus is at said upright state, and said second opposite side of said bulb is higher than said first side of said bulb while said apparatus is at said inverse state.

6. The heat-dissipating structure according to claim 1, wherein said air direction switching device comprises a vertical blocking board for guiding said wind flow to said first side of said bulb along said first wind direction, and a tilted blocking board for guiding said wind flow to said second opposite side of said bulb along said second wind direction.

7. The heat-dissipating structure according to claim 6, wherein said apparatus further comprises a bottom cover for placing thereon vertically said tilted blocking board.

8. The heat-dissipating structure according to claim 7, wherein said air direction switching device comprises a pivot for pivoting said tilted blocking board from a vertical status on said bottom cover to a horizontal status and switching from said guiding region of said vertical blocking board to said guiding region of said tilted blocking board, simultaneously.

9. The heat-dissipating structure according to claim 8, wherein said tilted blocking board is pivoted naturally from a vertical status on said bottom cover to a horizontal status by a gravity force while said apparatus is changed from said upright state to said inverse state.

10. The heat-dissipating structure according to claim 1, wherein the temperature at said first side of said bulb and second opposite side of said bulb are 860 and 820° C. respectively while said projector is at said upright state, and the temperature are 800 and 860° C. respectively while said apparatus is at said inverse state.

11. The heat-dissipating structure according to claim 1, wherein said wind flow along said first wind direction of said wind-supply device blows said first side of said bulb along a reflective lampshade.

12. The heat-dissipating structure according to claim 1, wherein said wind-supply device is mounted in front of the underside of said bulb base while said apparatus is at said upright state.

13. A heat-dissipating structure for switching an air direction for dissipating a heat generated from a bulb according to one of an upright state and an inverse state of an apparatus provided with said heat-dissipating structure and having a body placing thereon said bulb, comprising:
a wind-supply device mounted in said body for supplying a wind flow to a first side of said bulb for dissipating heat along a third wind direction while said apparatus is at said upright state; and
an air direction switching device mounted at the central location of a lateral side of said bulb base and including a guiding region for guiding said wind flow to a second opposite side of said bulb along a fourth wind direction while said apparatus is at said inverse state.

14. The heat-dissipating structure according to claim 13, wherein said apparatus is a liquid crystal projector.

15. The heat-dissipating structure according to claim 13, wherein a bulb base is mounted in said body for fixing said bulb.

16. The heat-dissipating structure according to claim 13, wherein said wind-supply device comprises a wind-delivery exit, and said air direction switching device includes a two-way blocking board mounted at a central location in front of said wind-delivery exit to be switched back and forth between said third and fourth wind direction.

17. The heat-dissipating structure according to claim 16, wherein said air direction switching device comprises a pivot, and said two-way blocking board includes a first wind-blocking side and a second wind-blocking side for being switched to said respective guiding region of said first and second wind-blocking sides through said pivot.

18. The heat-dissipating structure according to claim 12, wherein said air direction switching device comprises a first wind channel and a second wind channel for delivering said wind flow to said first side of said bulb and said second opposite side of said bulb respectively.

19. A heat-dissipating structure for switching an air direction for dissipating the heat generated from a bulb according to one of an upright state and an inverse state of an apparatus provided with said heat-dissipating structure and having a body placing thereon said bulb, comprising:
a first wind-supply device and a second wind-supply device mounted in said body for supplying a wind flow to a first side of said bulb for dissipating heat along a fifth wind direction while said apparatus is at said upright state; and
an air direction switching device mounted in said body and including a starting region for guilding said wind flow to a second opposite side of said bulb along a sixth wind direction while said apparatus is at said inverse state.

20. The heat-dissipating structure according to claim 19, wherein said apparatus is a liquid crystal projector.

21. The heat-dissipating structure according to claim 19, wherein a bulb base is mounted in said body for fixing said bulb.

22. The heat-dissipating structure according to claim 19, wherein said air direction switching device is a control circuit and includes said starting region.

23. The heat-dissipating structure according to claim 22, wherein said starting region is a screen control button electrically connected with said control circuit for switching the wind-supply function performed by said first wind-supply device to that performed by said second wind-supply device and activating said wind flow to said second opposite side of said bulb along said sixth wind direction.
